(19) United States
(12) Patent Application Publication
(10) Pub. No.: US 2017/0142160 A1
(43) Pub. Date: May 18, 2017

(54) Systems and Methods for Controlling Access to a Computer Device with Access Counting

(71) Applicant: Thi Chau Nguyen-Huu, Mississauga (CA)

(72) Inventor: Thi Chau Nguyen-Huu, Mississauga (CA)

(21) Appl. No.: 15/286,736

(22) Filed: Oct. 6, 2016

Related U.S. Application Data
(60) Provisional application No. 62/269,541, filed on Dec. 18, 2015.
(60) Provisional application No. 62/255,720, filed on Nov. 16, 2015.

(51) Int. Cl. H04L 29/06; H04L 12/26

(52) U.S. Cl. CPC H04L 63/20; H04L 43/16; H04L 43/0876; H04L 63/10

(57) ABSTRACT

A method and system for controlling access to a computer device with access counting is disclosed. The method involves operating a first computer and a second computer. The method includes operating the second computer to access the first computer; monitoring the second computer to determine a second access metric relative to the second computer; monitoring the first computer to determine a first access metric relative to the first computer; comparing the access metrics; and, based on comparing the access metrics, determining if an access condition is met, and, if the access condition is met, further permitting the second computer to access the first computer, otherwise interrupting access to the first computer by the one or more external computers.

### RELATED APPLICATIONS

This application claims priority from the U.S. Patent Application Nos. 62/269,541 filed on Dec. 18, 2015 entitled “SYSTEMS AND METHODS FOR CONTROLLING ACCESS TO A COMPUTER DEVICE WITH ACCESS COUNTING” and 62/255,720 filed on Nov. 16, 2015 entitled “SYSTEMS AND METHODS FOR CONTROLLING ACCESS TO A COMPUTER”, which are incorporated herein, in their entirety, by reference.

### FIELD

The described embodiments relate to systems and methods for controlling access to a computer device.

### BACKGROUND

In many situations, computer users can choose to store information in a cloud-based environment so as to permit ease of access and sharing of information. Cloud-based computer systems have been used to store private or sensitive information. In some cases, data may be stored on local or cloud-based data storage devices that use access passwords to control access to the data. Data on the data storage devices may be vulnerable to attacks which would enable an unauthorized entity to access the private or sensitive electronic data within the storage device.

### SUMMARY OF VARIOUS EMBODIMENTS

According to one aspect, a method of operating a first computer and a second computer. The method involves operating the second computer to access the first computer; monitoring the second computer to determine a second access metric relative to the second computer, wherein the second access metric measures a magnitude of data flow between the first computer and the second computer; monitoring the first computer to determine a first access metric relative to the first computer, wherein the first access metric measures a magnitude of data flow between the first computer and one or more external computers, the one or more external computers including the second computer; comparing the second access metric and the first access metric; and, based on comparing the second access metric and the first access metric, determining if an access condition is met, and, if the access condition is met, further permitting the second computer to access the first computer, otherwise interrupting access to the first computer by the one or more external computers.

The method may further include before operating the second computer to access the first computer, determining if the second computer is authorized to have access to the first computer.

In some cases, interrupting access to the first computer by the one or more external computers, includes again determining if the second computer is authorized to have access to the first computer before further permitting the second computer to access the first computer.

In some cases, monitoring the second computer to determine the second access metric includes measuring the magnitude of data flow between the first computer and the second computer starting after determining the second computer is authorized to have access to the first computer; and, monitoring the first computer to determine the first access metric includes measuring the magnitude of data flow between the first computer and the one or more external computers starting after determining the second computer is authorized to have access to the first computer.

In some cases, the second computer includes a plurality of second computers and the first computer is configured to establish a plurality of communication channels for the plurality of second computers, each communication channel in the plurality of communication channels being established for one of the plurality of second computers. The second access metric includes a plurality of channel-specific second access metrics, such that for each communication channel in the plurality of communication channels, the plurality of channel-specific second access metrics includes an associated channel-specific second access metric for measuring a magnitude of data flow for that communication channel. The first access metric includes a plurality of channel-specific first access metrics, the plurality of channel-specific first access metrics includes an associated channel-specific first access metric for each communication channel in the plurality of communication channels for measuring a magnitude of data flow between the first computer and the one or more external computers via that communication channel.

In some cases, comparing the second access metric and the first access metric includes determining whether the first access metric is greater than the second access metric; and if the first access metric is not greater than the second access metric, determining that the access condition is met, otherwise, further comparing the second access metric and the first access metric to determine if the access condition is met.

In some cases, comparing the second access metric and the first access metric includes determining an instant difference access metric between the first access metric and the second access metric, wherein the instant difference access metric comprises a magnitude and a polarity, the polarity of the instant difference access metric indicating whether the first access metric is greater than the second access metric; and determining whether the instant difference access metric is greater than a difference access threshold.

In some cases, the method may include, if the instant difference access metric is not greater than the instant difference access threshold, determining that the access condition is met; otherwise, determining that the access condition is not met.

In some cases, the method may include updating a cumulative difference access metric based on the instant difference access metric, wherein the cumulative difference access metric comprises a magnitude and a polarity, the polarity of the cumulative difference access metric indicating whether a summation of first access metrics is greater than a summation of second access metrics; and determining whether the updated cumulative difference access metric is greater than a cumulative difference access threshold.

In some cases, the method may include, if the updated cumulative difference access metric is not greater than the cumulative difference access threshold, determining that the access condition is met; otherwise, determining that the access condition is not met.

According to another aspect, a first computer includes a communication port for communicating with one or more external computers; a storage module; a non-transitory computer-readable storage medium storing instructions; and a processor configured to execute the instructions. The instructions may be executed to operate the first computer to permit the second computer to access the storage module of the first computer; receive a second access metric relative to the second computer, wherein the second access metric measures a magnitude of data flow between the first computer and the second computer; monitor the communication port to determine a first access metric relative to the first computer, wherein the first access metric measures a magnitude of data flow between the first computer and the one or more external computers; compare the second access metric and the first access metric; and, based on comparing the second access metric and the first access metric, determine if an access condition is met, and, if the access condition is met, further permitting the second computer to access the storage module of the first computer, otherwise interrupt access to the storage module of the first computer by the one or more external computers.

Other aspects and features will become apparent, to those ordinarily skilled in the art, upon review of the following description of some exemplary embodiments.

### BRIEF DESCRIPTION OF THE DRAWINGS

A preferred embodiment of the present invention will now be described in detail with reference to the drawings, in which:

FIG. 1 is a block diagram of a target device and a host system in accordance with at least one example embodiment;

FIG. 2 is a block diagram of a cloud-environment having a hypervisor, at least one virtual machine and physical hardware, in accordance with at least one example embodiment; and

FIG. 3 is a flowchart illustrating a process for access counting, in accordance with at least one example embodiment.

### DETAILED DESCRIPTION OF EXEMPLARY EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices, in known fashion.

Each program may be implemented in a high level procedural or object oriented programming or scripting language, or both, to communicate with a computer system. Alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system can also be considered to be implemented as a non-transitory computer-readable storage medium, configured with a computer program, where the storage medium so configured causes a computer to operate in a specific and pre-defined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or RAM, where the data stored thereon is only temporarily stored. The computer useable instructions can also be in various forms, including compiled and non-compiled code.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, this description and the drawings are not to be considered as limiting the scope of the embodiments described herein in any way, but rather as merely describing the implementation of the various embodiments described herein.

The availability of low-cost and high-capacity networks, inexpensive storage devices and hardware has accelerated the growth of cloud-based computing.

Cloud-based computing infrastructures capable of providing decentralized delivery of data and computing resources have become an appealing alternative to operating and maintaining dedicated computing infrastructure. As such, the protection of private and sensitive information unauthorized access within the cloud-based environment may become increasingly important.

The various embodiments described herein generally relate to a method (and related system) for operating a computer device to control access to the computer device by a computer system. In at least one embodiment, the computer device can be a data storage device, such as a physical disk drive. In at least one embodiment, the data storage device can be a self-encrypting drive (“SED”). In at least one embodiment, the computer device can be physical servers within a datacenter environment.

Access to the computer device by a computer system, or “authentic”, or “authorized” computer system, may be controlled to guard against other computer systems, or “imposters”, from spoofing or masquerading as the authentic computer system. Imposters can pretend to be the authentic system in order to access and obtain protected or sensitive data from the computer device.

Generally, in an exemplary embodiment of the invention, the computer component, to which access is being granted (the “target device”), can act as the stakeholder. The target device can act as a stakeholder, verifying that a second computer component, for which access is being sought (the “host system”), is the authentic host system. With the target device being the stakeholder, host systems may be regarded as “external” entities seeking to access the stakeholder. That is, both authentic and imposter computer systems may be regarded as external computers systems to the target device.

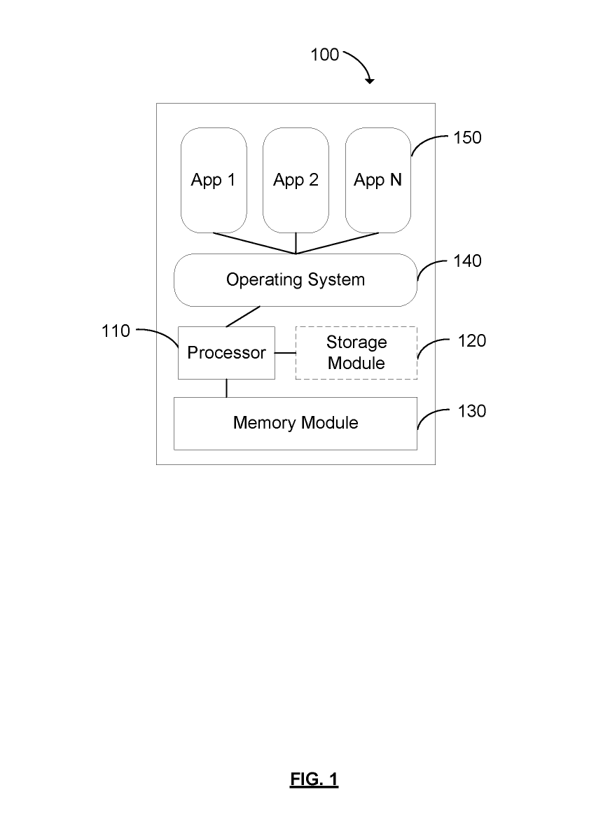

Reference is first made to FIG. 1, which illustrates a block diagram of a computer system 100 comprising hardware and software components, according to at least one example embodiment. The hardware components can comprise at least a processor 110, storage module 120 and a memory module 130. The software components can comprise the operating system software 140 and system applications 150. The operating system software 140 can function to facilitate and manage access to the hardware components by the system applications 150.

While FIG. 1 depicts storage module 120 being a component within the computer system 100, in some embodiments, storage module 120 can be a physical storage device external to the computer system 100. In some embodiments, storage module 120 may be a fixed large capacity internal hard disk drive or an externally connected hard disk drive, or solid-state drive. In other embodiments, storage module 120 can be a mapped or mounted network-accessible drive. In some embodiments, the storage module 120 can be a self-encrypting drive (SED).

With respect to the relationship between the storage module 120 and the computer system 100, the storage module 120 may be regarded as a target device and the computer system 100 authorized to access the target device may be regarded as the host system. A session can be started if the host system is authorized to access to the target device. During the session, the host system may be provided access to the target device and the target device can also monitor the session to determine if the session should be terminated. When the target device determines that the session should be terminated, access to the target device can be blocked.

In some embodiments, such as a target device that is a network-accessible drive, the target device may be accessed by several host systems concurrently. In some embodiments, the target device may establish a communication channel for each host system that is authorized to access the target device, or some portion of the target device. In some embodiments, the target device may establish multiple communication channels for an authorized host system. Host systems should only be able to access the target device via the one or more communication channels established for that host system. However, host systems should not be able to access the target device via communication channels established for other host systems.

An example of a target device that establishes multiple communication channels for a single host system is when the host system is a computer system that supports multiple, concurrent user logins. A first user may initially log into the computer system and have permission to access a network-accessible drive. Subsequently, a second user may require use of the computer system. The second user may be a system administrator that is permitted to perform administrative functions for the computer system that the first user is not permitted to perform. The second user may also have permission to access the same network-accessible drive; however the second user may have different permissions than that of the first user. Users may take turns in using the computer system. For convenience, the computer system may support multiple, concurrent logins so that a second user may log into the computer system without requiring the first user to log out of the computer system. When multiple users are logged into one computer system (i.e., host system), the network-accessible drive (i.e., target device) may have established multiple communication channels to the computer system.

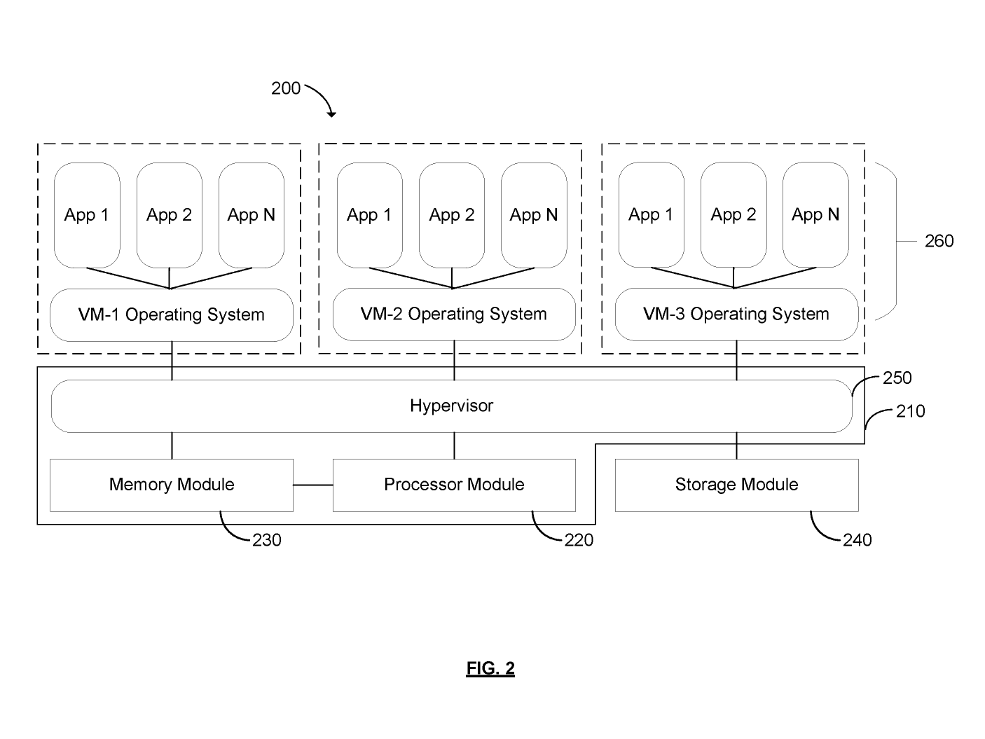

Reference is now made to FIG. 2, which illustrates a block diagram of a cloud-based computing environment 200, according to at least one example embodiment. The cloud-based computing environment can be established using physical servers 210 within a datacenter environment and be managed by a cloud provider. The physical servers 210 can comprise a processor module 220 having one or more computer processors (not shown), a memory module 230 comprising RAM memory or any high-speed memory, and a storage module 240 comprising large capacity storage such as, for example, hard disk drives and/or solid state drives. In some embodiments the large capacity storage can be a self-encrypting drive (SED).

The physical server 210 can operate a software hypervisor 250 configured to create and manage one or more virtual machines (VMs) 260. The VMs 260 can be allocated physical server resources, by the hypervisor 250, including network resources (not shown); storage resources such as disk space corresponding to a portion of the physical storage in the storage module 240; and computing resources such as processing resources in the processor module 220 and (RAM) memory corresponding to a portion of the physical memory in the memory module 230. Allocation of server resources can permit the VMs 260 to function as a computer similar to the computer system 100 of FIG. 1. Allocation of server resources to VMs 260 may be static or dynamic. While FIG. 2 depicts storage module 240 being a component external to the physical server 210, in some embodiments, storage module 240 can be a physical storage device within the physical server 210.

The VMs 260 can operate its own operating system and system applications. For example, the operating system labeled “VM-1” can be an open-source operating system such as Linux®, while the operating system labeled “VM-2” can be a proprietary operating system such as the Windows® operating system. As such, although each VM can rely on the same hardware resources, they can nevertheless operate independently with respect to each other.

Additionally, each VM may be associated to a cloud user. The cloud user can be an individual or a group of individuals in a corporation. The cloud user can specify to the cloud provider the computing resources desired. In turn, the cloud provider can create and configure a VM having the appropriate computing resources using the hypervisor 250. For example, one cloud user can request the cloud provider to configure a VM to operate a web server for electronic commerce. Another cloud user can request a VM to be configured to facilitate cloud-based storage. In the latter case, more storage allocation may be justified than in the former case. However, in both cases, sensitive or private information belonging to the VM's respective cloud user may be stored in the respective VM's allocated storage space. Therefore, access to the stored data should only be granted to the cloud user through the VM.

The cloud provider generally owns or manages, or both owns and manages, the physical hardware such as the physical storage devices within the storage module 220. Consequently the data belonging to the cloud user can be physically in the possession of the cloud provider, held within the datacenter facility. It is therefore possible that the portions of the cloud user's data may be surreptitiously accessed by a malign agent that circumvents the cloud provider's security protections. In cloud storage systems, the cloud user's data can be stored in encrypted form, and may thus be inaccessible by a malign agent. However, when the VM and the cloud user are accessing their data, a malign agent may access that data without the cloud user, or their respective VM's knowledge.

Similar to the computer system 100 of FIG. 1, each of the VMs 260 may be regarded as a host system. Generally, each VM 260, or host system, may only access the portion of the storage module 240, that the hypervisor 250 has allocated to that host system. Thus, each VM 260 may regard the portion of the storage module 240 that is allocated to the VM 260 as a dedicated storage module such as storage module 120 of computer system 100. That is, each portion of the storage module 240 may be regarded as a target device to a host system and the storage module 240 may form a plurality of target devices. Storage module 240 may comprise one physical device, or may alternatively comprise multiple physical devices, and each target device may be provided in one or more of the physical devices.

Access to a target device by a host system may first require authorization of host system. A session may be started if the host system is authorized to have access to the target device. During the session, the host system may be provided access to the target device. At the same time, the target device can monitor the session to determine if the session should be terminated. When the target device determines that the session should be terminated, access to the target device may be blocked.

In some embodiments, the storage module 240 may be accessed by several VMs 260, concurrently. That is, the target device may be accessed by several host systems concurrently. The target device may establish one or more communication channels for each host system that is authorized to access the target device. In some embodiments, the target device may establish multiple communication channels for an authorized host system. Host systems should only be able to access the target device via the one or more communication channels established for that host system. That is, host systems should not be able to access, or at least are not authorized to access, the target device via communication channels established for other host systems. If a first host system accesses the target device via a communication channel established for a second host system, then the first host system can be considered a malign agent, at least vis-à-vis that communication channel and the portions of the target device to which that communication channel grants access.

As described in co-pending application for “Systems and Methods for Controlling Access to a Computer Device” (U.S. patent application Ser. No. 14/827,805), the content of which is hereby incorporated by reference, access to a target device such as a self-encrypted drive may be controlled through the exchange of a cryptographic heartbeat between the host system and target device. The heartbeat exchange can comprise exchanging a series of challenges and responses between the target device and the host system, respectively. For instance, in some embodiments, only the authentic host system may be capable of producing a correct response. In such embodiments, if the target device receives a number of incorrect responses greater than a defined threshold, then the target device can terminate the session. Upon termination of the session, the self-encrypted drive can return to a locked state in which the data stored within is not accessible. The exchange of a cryptographic heartbeat may be particularly effective against so-called “hot-swap” cable attacks, wherein after the storage device is unlocked, an attacker at the data center can physically unplug the data cable of the data storage device and plug the unlocked data storage device to another computer, or imposter host, to access the data.

Exchanging cryptographic heartbeats within the cloud environment can impede unauthorized host systems (i.e. VMs within the cloud environment) from directly accessing a target device by posing as an authorized host system. It may still be possible, however, for an unauthorized host system to gain access to the target device via the hypervisor. That is, an active session between the target device and an authorized host system may provide an opportunity for a malign agent to make unauthorized accesses to the target device without the authorized host system's knowledge.

Examples of malign agents include, but are not limited to rogue hypervisors and rogue VMs. A hypervisor may be considered “rogue” if it has been configured to perform unauthorized data operations (e.g. read/write operations) on a target device. For example, a malignant system administrator physically located at the datacenter environment might re-configure the hypervisor through a server console to surreptitiously read the data stored on a target device, or write data to the target device, that only the authorized host system should be able to access. A VM may be considered “rogue” if it has been configured to masquerade as an authentic VM and access the target device of the authentic VM. In other instances, a security flaw of the hypervisor may be exploited by a cloud user through its VM (i.e. an unauthorized host system) to configure the hypervisor to access, on its behalf, the target device authorized for use by another cloud user.

In some embodiments, to impede unauthorized access to the target device during the session, the target device can implement an access counting process to measure access to the target device by the host system. The measure of access may be made with respect to the session or some other pre-defined time interval as described in more detail below.

In some embodiments, an access counting process may determine the number of times the host system has accessed the target device. In the case of a storage device, an “access” can correspond to the number of data read/write requests, or “access requests” issued by the authorized host system, or the amount of data accessed on the target device, or both. Generally, each read request can require reading some amount of data on the target device and each write request can require writing some amount of data to the target device. Therefore, in some embodiments where access counting relates to the amount of data being accessed, then each access request may be parsed to determine the amount of data to be read or written for that access request. The amount of data accessed on the target device may relate to sectors of data, or blocks of data, or any suitable metric of data. As discussed in more detail below, recording the number of times that a host system has accessed the target device can allow detection of outside or unauthorized access of that target device. The measure of access may be any suitable metric, including but not limited to integer and decimal forms. Examples of a measure of access include 64 kilobytes (KB), 1.2 gigabytes (GB), or 50 access requests.

The measure of access may be determined for each communication channel. Each host system may maintain an access count for the communication channel that the host system uses to access the target device. The target device may maintain an access count for each communication channel established for that host system. That is, when the target device is accessed by multiple host systems, the target device may maintain an access count for each communication channel.

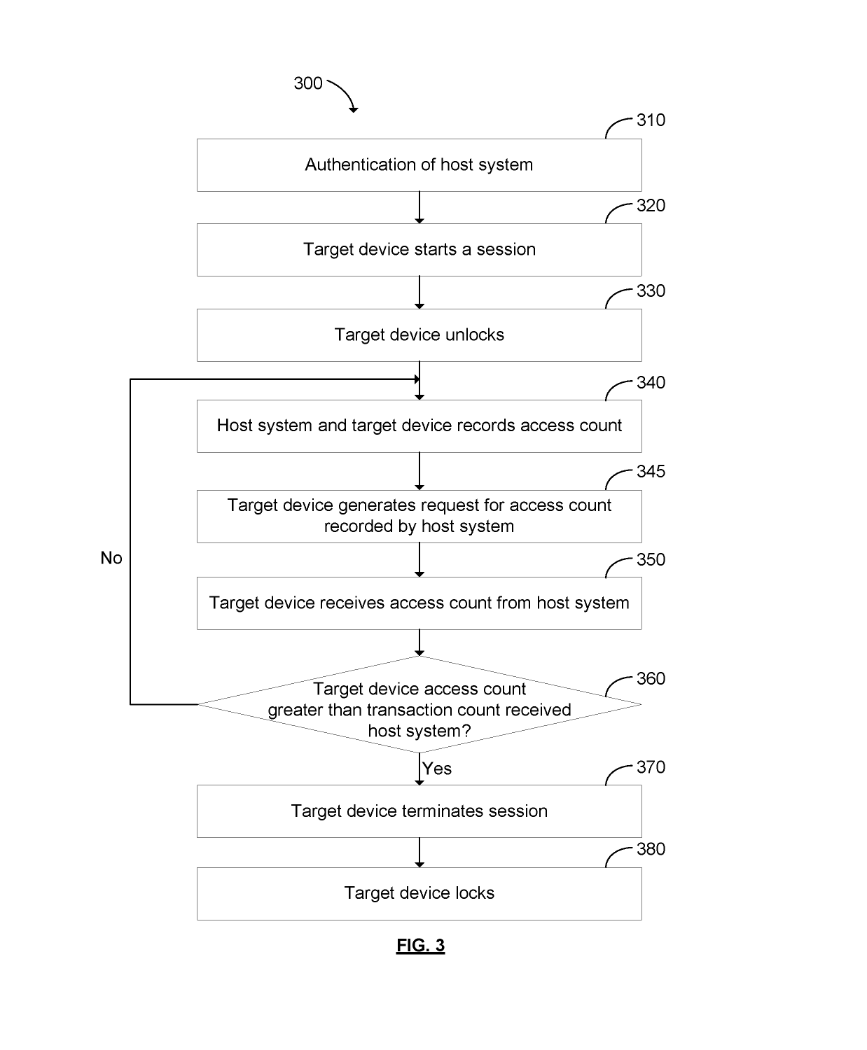

Reference is made to FIG. 3, which illustrates a flowchart 300 of an example process of access counting to detect whether or not there has been potentially unauthorized access, according to at least one example embodiment.

At step 310, the host system may be authenticated. In some embodiments, authentication of the host system may be provided by a cloud user logging into a VM operating system. In some embodiments, authentication of the host system may be provided by a user at the host system providing authentication to access an SED. At step 320, the target device can start a session after authentication is verified.

At step 330, the target device can unlock itself to make the data on the target device accessible. In some embodiments, the target device can make the data accessible to the cloud user via the VM. In some embodiments, unlocking the target device can include disengaging other protective measures (e.g. unencrypting the contents of the target device).

At step 340, both the target device and host system can independently begin counting the number of accesses taking place. In some embodiments, the method of counting can involve keeping track of the total number of accesses for the session. In other embodiments, an upper limit may be set for a given session such that the access count would reset to zero and begin counting therefrom. For example, if the upper limit is set to 2049, then the next count would be 0 followed by 1 and so on. Any appropriate upper limit value may be used.

In yet other embodiments, the access count can reset after a pre-defined time interval has elapsed. For example the count may be reset after every hour or month. Any appropriate time interval may be used. Access counts that are reset after a pre-defined time interval has elapsed are called “interval-specific access counts” in the description that follows. Access counts that are not reset after a pre-defined time interval has elapsed are called “cumulative access counts” in the description that follows. Generally, cumulative access counts may be session based; that is, they may be reset before a session begins or after a session terminates. Generally, cumulative access counts are not reset during a session. The manner of counting may be pre-configured or negotiated between the target device and the host system upon establishment of a session, but before any data is accessed.

In some embodiments, access counting may be performed by one or more monitoring devices. For example, a first monitoring device may determine the access count for the target device while a second monitoring device may determine the access count for the host system. In another example, a monitoring device may determine the access count for the host system while the target device may determine the access count for itself. In another example, a monitoring device may determine the access count for the target device while the host system may determine the access count for itself. In another example, a monitoring device may determine the access counts for each of the target device and the host system. Access counting that is performed by a monitoring device may increase the transmission payload.

For a given method of counting, the number of accesses tallied by each of the host system and target device may be the same as long as no unauthorized entity such as the rogue hypervisor or the rogue VM attempts to access the target device. If unauthorized access occurs, then the access count recorded by the target device may be different from that of the host system. When the access counts correspond to access requests, the target device may be receiving more access requests than those that are actually being sent by the host system. When the access counts correspond to the amount of data accessed, more data may be accessed for each access request than that which is actually being requested by the host system.

At step 345, the target system can generate a request for an access count from the host system. In some embodiments, the access count requests may be made at pre-defined time intervals. Any suitable pre-defined time interval may be used. In other embodiments, a request interval can relate to the method of counting employed. For example, if the method of counting requires the count to reset after a pre-defined time interval, then the request for access count may be issued immediately prior to the count being reset. In other embodiments, the number of access count requests can increase proportionately with the number of read access requests received by the target device. In yet other embodiments, the access count requests may be made randomly to ensure that, for instance, the access count requests would not be intercepted and discarded, or falsely responded to, by the rogue hypervisor or the rogue VM. In yet other embodiments, the access count request may be in the form of an encrypted message that only the host system can decrypt.

In some embodiments, the host system can unilaterally provide the target device its access count without first receiving an access count request from the target device. Again, the frequency of transmission may be at a pre-defined time interval or randomly, or proportional to the number of access requests issued by the host system. The provision of an access count may be in the form of an encrypted message that only an authentic host system can encrypt with its encryption key and only the target device can decrypt.

At step 350, the target device can receive the access count from the host system. At step 360, a comparison may be made between the access count tallied by the host system and the access count tallied by the target device. Where each access corresponds to an access request, then if the access count recorded by the target device is greater than the access count reported by the host system, the difference may be an indication that the target device is receiving access requests that did not originate from the authentic host system. Instead, the access requests may originate from another entity that may not be the authorized entity (a malign agent) such as the rogue hypervisor or the rogue VM.

In some embodiments, the comparison may be made by a monitoring device. Each of the target device and the host system may transmit an access count to the monitoring device. The monitoring device may receive the access count from each of the target device and the host system and compare the access counts. Comparison of access counts by a monitoring device may increase the transmission payload.

Under some circumstances, the rogue hypervisor or the rogue VM can “piggyback” off of read or write requests provided by the authentic host system to cause additional data that was not requested by the authentic host to be read or written to. When this happens, more data of the target device may be accessed than that which is actually being requested by the host system. If the access count corresponds to an amount of data and the access count recorded by the target device is greater than the access count reported by the host system, the difference can indicate that additional data, not requested by the authentic host system, may have been accessed. Instead, another entity such as the rogue hypervisor or rogue VM may be tampering with the access requests and intercepting the data accessed.

Generally, an access count tallied by the host system that is greater than the access count tallied by the target device will not be taken to indicate potentially unauthorized access. Differences are determined by subtracting the host system tally from the target device tally, or vice versa. Thus, differences include a magnitude and a polarity. When the host system tally is subtracted from the target device tally, differences that are negative values, or have a negative polarity, indicate an access count tallied by the host system that is greater than the access count tallied by the target device and will not be taken to indicate potentially unauthorized access. When the host system tally is subtracted from the target device tally, differences that are positive values, or have a positive polarity, indicate an access count tallied by the target system that is greater than the access count tallied by the host system. When differences are determined by subtracting the target device tally from the host system tally, differences having a negative polarity will be taken to indicate potentially unauthorized access and differences having a positive polarity will not be taken to indicate potentially unauthorized access. When the access count tallied by the host system is equal to the access count tallied by the target device, the magnitude of the difference will be zero and the polarity is irrelevant. When the magnitude of the difference is zero, the polarity may be negative or positive.

In some embodiments, a difference in the interval-specific access count may be permitted. A difference in the interval-specific access count may arise because of time delays in the transmission of access requests from the host system to the target device. For example, due to the time delay between the host system transmitting the access request and the target device receiving and processing the access request, a difference may arise in the access counts tallied by the host system and the target device. If an access count is transmitted to the target device before the target device receives and processes the access request, then the access count received by the target device from the host system may be greater than from the access count tallied by the target device. Alternatively, a difference in the interval-specific access count may also arise when data is being accessed when the access count is transmitted.

In at least one embodiment, the permitted difference in the interval-specific access count may be limited. That is, a difference in the interval-specific access count within a threshold may be permitted; conversely, a difference in the interval-specific access count greater than the threshold may be taken to indicate potentially unauthorized access. A suitable threshold for the difference in the interval-specific access count may be determined depending on factors such as i) the expected range of time delays between the host system transmitting the access request and the target device receiving and processing the access request, and ii) the range of access count increments that can be expected within that time interval.

The time delay between the host system transmitting the access request and the target device receiving and processing the access request may depend on network resource capacity and utilization. During maintenance of network resources, or during high utilization periods, the time delay may be greater. As well, some embodiments of the access counting protocol may increase the transmission payload, and thus, increase network utilization. In such circumstances, the threshold for the difference in the interval-specific access count may be increased to decrease the likelihood of a false positive detection of an attack (determining that an attack may be taking place when, in fact, no attack is taking place). Alternatively, the threshold for the difference in the interval-specific access count may be decreased to decrease the likelihood of a false negative detection of an attack (determining that no attack is taking place when, in fact, an actual attack is taking place). This can be done, for example, where the data on the target device rendered accessible by a particular communication channel is highly confidential or sensitive, or where such data appears to be of interest to potential malign agents such as when frequent previous attempts have been made to access this data. The threshold for the difference in the interval-specific access count may be dynamically adjusted based on network resource capacity and utilization.

The following table provides examples of interval-specific access counts. In this example, there are differences between the interval-specific access count tallied by the target device and the interval-specific access count tallied by the host system for each interval. In this example, differences are determined by subtracting the host system tally from the target device tally. Thus, differences that have negative polarity indicate an access count tallied by the host system that is greater than the access count tallied by the target device and will not be taken to indicate potentially unauthorized access. In this example, a threshold value of +8 may be used for the difference in interval-specific access count that may be taken to indicate potentially unauthorized access.

In at least one embodiment, a cumulative difference in interval-specific access counts may be used to detect whether potentially unauthorized access has occurred. A cumulative difference in interval-specific access counts may be determined by adding all differences in interval-specific access counts of the session thus far. Thus, differences in interval-specific access counts may be regarded as an “instant difference” because it compares access counts of a particular interval within the session. Cumulative differences in interval-specific access counts may be regarded as a “cumulative difference” because it compares the aggregation of access counts within the session. Similar to a difference in the interval-specific access count, a cumulative difference in interval-specific access counts includes a magnitude and polarity. A difference in the cumulative difference in interval-specific access counts within a threshold may be permitted; meanwhile, a difference in the cumulative difference in interval-specific access count greater than the threshold may be taken to indicate potentially unauthorized access. Any suitable threshold for the difference in the interval-specific access count may be used. In this example, a threshold value of +5 may be used for the cumulative difference in interval-specific access count. As shown in intervals 4 and 8, the cumulative difference in interval-specific access count may be taken as having a magnitude of zero and a positive polarity.

| | Target Device | Host System | Difference | Cumulative |
|---|---|---|---|---|
| | Interval- | Interval- | in Interval- | Difference in |
| | Specific | Specific | Specific | Interval- |
| | Access | Access | Access | Specific |
| No. | Count | Count | Count | AccessCount |
| 1 | 9 | 10 | −1 | −1 |
| 2 | 12 | 10 | +2 | +1 |
| 3 | 7 | 10 | −3 | −2 |
| 4 | 12 | 10 | +2 | +0 |
| 5 | 9 | 10 | −1 | −1 |
| 6 | 14 | 10 | +4 | +3 |
| 7 | 5 | 10 | −5 | −2 |
| 8 | 12 | 10 | +2 | +0 |

In some embodiments, a difference in the cumulative access count may be used to detect whether potentially unauthorized access has occurred. A difference in cumulative access counts may be regarded as a “cumulative difference” because it compares the aggregation of access counts within the session. Similar to a difference in the interval-specific access count and a cumulative difference in the interval-specific access counts, a difference in cumulative access counts includes a magnitude and a polarity. Also similar to a difference in the interval-specific access count, a small difference in the cumulative access count, that does not exceed some threshold difference, may be permitted to account for time delays in the transmission of access requests or when data is in the process of being accessed. In contrast to the interval-specific access count, the cumulative access count may include the access counts that have occurred before the immediate interval for which the access count is being transmitted. A suitable threshold for the difference in cumulative access count may be determined depending on factors such as i) the expected range of time delays between the host system transmitting the access request and the target device receiving and processing the access request.

The following table is an example of cumulative access counts, wherein the measure of access relates to data. In this example, there are differences between the cumulative access count tallied by the host system and the cumulative access count tallied by the target device. In this example, a threshold value of +5 megabytes (MB) may be used for the difference in cumulative access count that is indicative of potentially unauthorized access. In this embodiment, since the difference in cumulative access count does not exceed the threshold value of +5 MB, potentially unauthorized access is not detected.

| | Target Device | Host System | Difference in |
|---|---|---|---|
| | Cumulative | Cumulative | Cumulative |
| | Access Count | Access Count | Access Count |
| No. | (MB) | (MB) | (MB) |
| 1 | 9.2 | 10.2 | −1.0 |
| 2 | 21.1 | 20.3 | +0.8 |
| 3 | 28.8 | 30.1 | −1.3 |
| 4 | 40.6 | 40.2 | +0.4 |
| 5 | 49.5 | 50.6 | −1.1 |
| 6 | 63.3 | 60.4 | +2.9 |
| 7 | 68.4 | 70.9 | −2.5 |
| 8 | 80.2 | 80.4 | −0.2 |

An interval-specific access count generally requires less transmission payload than a cumulative access count because the interval-specific access count is reset throughout a session and will generally have a smaller value. In some embodiments, both the interval-specific access count and the cumulative access count may be used. In such embodiments, the host system may transmit an interval-specific access count to the target device. The target device may tally the interval-specific access counts received from the host system to determine a cumulative access count at the host system for comparison with the cumulative access counts tallied based on access requests received or sectors accessed.

In some embodiments, the target device may determine the thresholds for differences in access counts (e.g., difference in the interval-specific access count threshold, cumulative difference in the interval-specific access count threshold, or difference in cumulative access count threshold). However, generally, host systems may have greater intelligence and awareness of the application, that is, the context of the data stored on the target device. In addition, the host system, or the user of the host system, may have a better idea than the target device about the sensitivity of the data stored on the target device, as well as of the steps likely to be taken by malign agents, trying to access this data. Accordingly, it may be more appropriate for host systems to determine the thresholds for differences in access counts.

In some embodiments, the target device and host system may negotiate the thresholds for differences in access counts. For example, the host system may determine a level of protection that it requires. The target device may propose thresholds as options and the host system may choose from amongst the options. If the host system does not find any of the options presented by the target device to be acceptable, then the host system may terminate the session. In some cases where a heartbeat is exchanged between a target device and a host system, the host system may terminate the session by not exchanging the heartbeat.

In other embodiments, the target device can determine the likelihood of an unauthorized access based on a statistical analysis. For example, the access counts can include a calculation of certain statistical metrics, such as the length of time between access requests, the distribution of the length of time between the target device being accessed, the average number of times that the target device is accessed for a given time interval, the distribution of the times at which the target device is accessed. The target device may be configured to receive and store acceptable thresholds for the statistical metrics. In addition, the target device may be configured to calculate statistical metrics based on past or historical information and to determine acceptable thresholds based on the calculated statistical metrics. Historical information, for example, may relate to the average number of accesses per hour for a given target device. An acceptable range of one standard deviation may be adopted, so that a sudden and significant increase in the number of times that the target device is accessed per hour may indicate unauthorized access. Acceptable ranges may be selected to increase the likelihood of detecting an attack or to decrease the likelihood of a false positive detection of an attack, or both.

At step 370, upon determining that there exists a difference in access count or that certain statistical metrics have deviated from a corresponding acceptable range, the target device can terminate the session. In some embodiments, upon determining that there is a difference in access counts, the target device can terminate the session immediately, or after a delay. Any suitable time period for a delay may be used. In some embodiments, the session may be terminated within seconds or milliseconds.

When a target device is accessed by multiple host systems, the session may be host-specific. That is, the target device may terminate the communication channel established for the host system that has an unacceptable discrepancy in access count while maintaining communication channels established for other host systems that do not have unacceptable discrepancies in access count. In some embodiments where the target device establishes multiple communication channels for a host system, the target device may terminate all communication channels established for that host system when any one communication channel for that host system has an unacceptable discrepancy in access count.

In other embodiments, the session may be communication channel-specific. In embodiments where the target device establishes multiple communication channels for a host system, the target device may terminate only the communication channel that has an unacceptable discrepancy in access count while maintaining other communication channels established for the same host system that do not have unacceptable discrepancies in access count.

After the target device terminates the session at step 370, the target device can lock itself at step 380. As mentioned previously, in some embodiments, locking the target device can include engaging other protective measures (e.g. encrypting the contents of the target device).

In some embodiments, additional steps may be taken before the target device proceeds to step 380 and locks itself. For example, the target device may notify the host system of the discrepancy. The target device may further provide the host system an option to continue the session despite the discrepancy. The target device may inform the host system of the risks of continuing the session when there is a discrepancy in access counts. The target device may also require authentication of the host system in order to continue the session despite the discrepancy.

In some embodiments, after determining that a discrepancy exists, the target device may initiate an audit. The audit may include determining which data operations were unauthorized, determining the information that was read or written by an unauthorized host system, and where the information was sent to or received from.

In some embodiments, the target device may further determine how unauthorized data operations were made. The target device may also query, or provide challenges to, the hypervisor to determine whether the hypervisor is authentic.

To impede fraudulent access counts or manipulation of the access counts by malign agents, the access counting process can be implemented within software components that are not easily altered. For example, in some embodiments, the access counting process may be implemented within the firmware of the target device, SED, or physical disk drives.

In some embodiments, the target device and host system count the services being rendered.

The present invention has been described here by way of example only. Various modification and variations may be made to these exemplary embodiments without departing from the spirit and scope of the invention.

1. A method of operating a first computer and a second computer, the method comprising:
operating the second computer to access the first computer;
monitoring the second computer to determine a second access metric relative to the second computer, wherein the second access metric measures a magnitude of data flow between the first computer and the second computer;
monitoring the first computer to determine a first access metric relative to the first computer, wherein the first access metric measures a magnitude of data flow between the first computer and one or more external computers, the one or more external computers comprising the second computer;
comparing the second access metric and the first access metric; and,
based on comparing the second access metric and the first access metric, determining if an access condition is met, and, if the access condition is met, further permitting the second computer to access the first computer, otherwise interrupting access to the first computer by the one or more external computers.

2. The method of claim 1 further comprising, before operating the second computer to access the first computer, determining if the second computer is authorized to have access to the first computer.

3. The method of claim 2, wherein interrupting access to the first computer by the one or more external computers, comprises again determining if the second computer is authorized to have access to the first computer before further permitting the second computer to access the first computer.

4. The method as defined in claim 2, wherein:
monitoring the second computer to determine the second access metric comprises measuring the magnitude of data flow between the first computer and the second computer starting after determining the second computer is authorized to have access to the first computer; and,
monitoring the first computer to determine the first access metric comprises measuring the magnitude of data flow between the first computer and the one or more external computers starting after determining the second computer is authorized to have access to the first computer.

5. The method of claim 1, wherein:
the second computer comprises a plurality of second computers;
the first computer is configured to establish a plurality of communication channels for the plurality of second computers, each communication channel in the plurality of communication channels being established for one of the plurality of second computers;
the second access metric comprises a plurality of channel-specific second access metrics, such that for each communication channel in the plurality of communication channels, the plurality of channel-specific second access metrics comprises an associated channel-specific second access metric for measuring a magnitude of data flow for that communication channel;
the first access metric comprises a plurality of channel-specific first access metrics, the plurality of channel-specific first access metrics comprising an associated channel-specific first access metric for each communication channel in the plurality of communication channels for measuring a magnitude of data flow between the first computer and the one or more external computers via that communication channel;
operating the second computer to access the first computer comprises, for each second computer and each communication channel, operating that second computer to access the first computer via that communication channel;
determining if the access condition is met comprises, for each communication channel in the plurality of communication channels, determining if the access condition is met for that communication channel;
monitoring the second computer to determine the second access metric comprises monitoring the plurality of second computers to determine the plurality of channel-specific second access metrics;
monitoring the first computer to determine the first access metric comprises monitoring the first computer at the plurality of communication channels to determine the plurality of channel-specific first access metrics;
comparing the second access metric and the first access metric comprises, for each communication channel in the plurality of communication channels, comparing the channel-specific first access metric and the channel-specific second access metric for that communication channel and that second computer;
based on comparing the channel-specific first access metric and the channel-specific second access metric for each communication channel and each second computer, determining if the access condition is met, and, if the access condition is met, further permitting that second computer to access the first computer via that communication channel, otherwise interrupting access to the first computer by the one or more external computers via that communication channel.

6. The method of claim 5 further comprising, for each second computer in the plurality of second computers, before operating that second computer to access the first computer, determining if that second computer is authorized to have access to the first computer.

7. The method of claim 6, wherein for each second computer in the plurality of second computers and the communication channel established for that second computer, interrupting access to the first computer by the one or more external computers via that communication channel, comprises again determining if that second computer is authorized to have access to the first computer via that communication channel before further permitting that second computer to access the first computer via that communication channel.

8. The method of claim 6, wherein:
monitoring the plurality of second computers to determine the plurality of channel-specific second access metrics comprises, for each second computer in the plurality of second computers and the communication channel established for that second computer, measuring the magnitude of data flow between the first computer and that second computer via that communication channel starting after determining that second computer is authorized to have access to the first computer via that communication channel; and,
monitoring the first computer at the plurality of communication channels to determine the plurality of channel-specific first access metrics comprises, for each communication channel established for a second computer, measuring the magnitude of data flow between the first computer and the one or more external computers via that communication channel starting after determining that second computer is authorized to have access to the first computer via that communication channel.

9. The method of claim 4, wherein comparing the second access metric and the first access metric comprises:
determining whether the first access metric is greater than the second access metric; and
if the first access metric is not greater than the second access metric, determining that the access condition is met,
otherwise, further comparing the second access metric and the first access metric to determine if the access condition is met.

10. The method of claim 4, wherein comparing the second access metric and the first access metric comprises:
determining an instant difference access metric between the first access metric and the second access metric, wherein the instant difference access metric comprises a magnitude and a polarity, the polarity of the instant difference access metric indicating whether the first access metric is greater than the second access metric; and
updating a cumulative difference access metric based on the instant difference access metric, wherein the cumulative difference access metric comprises a magnitude and a polarity, the polarity of the cumulative difference access metric indicating whether a summation of first access metrics is greater than a summation of second access metrics;
determining whether the updated cumulative difference access metric is greater than a cumulative difference access threshold; and
if the updated cumulative difference access metric is not greater than the cumulative difference access threshold, determining that the access condition is met;
otherwise, determining that the access condition is not met.

11. The method of claim 4, wherein comparing the second access metric and the first access metric comprises:
determining an instant difference access metric between the first access metric and the second access metric, wherein the instant difference access metric comprises a magnitude and a polarity, the polarity of the instant difference access metric indicating whether the first access metric is greater than the second access metric;
determining whether the instant difference access metric is greater than an instant difference access threshold; and
if the instant difference access metric is not greater than the instant difference access threshold, determining that the access condition is met;
otherwise, determining that the access condition is not met.

12. The method of claim 4, wherein comparing the second access metric and the first access metric comprises:
determining an instant difference access metric between the first access metric and the second access metric, wherein the instant difference access metric comprises a magnitude and a polarity, the polarity of the instant difference access metric indicating whether the first access metric is greater than the second access metric;
determining whether the instant difference access metric is greater than a difference access threshold;
updating a cumulative difference access metric based on the instant difference access metric, wherein the cumulative difference access metric comprises a magnitude and a polarity, the polarity of the cumulative difference access metric indicating whether a summation of first access metrics is greater than a summation of second access metrics;
determining whether the updated cumulative difference access metric is greater than a cumulative difference access threshold; and
if the updated cumulative difference access metric is not greater than the cumulative difference access threshold, and the instant difference access metric is not greater than the instant difference access threshold, determining that the access condition is met;
otherwise, determining that the access condition is not met.

13. The method of claim 1, wherein:
the first access metric comprises a series of first access metrics;
the second access metric comprises a series of second access metrics, the series of first access metrics and the series of second access metrics being determined for a sequence of time periods, wherein each first access metric of the series of first access metrics is measured over the same time period as a corresponding second access metric of the series of second access metrics;
comparing the second access metric and the first access metric comprises comparing a second access metric of the series of second access metrics to the corresponding first access metric of the series of first access metrics measured over the same time period.

14. The method of claim 13 further comprising, determining a time delay of transmitting access requests from the second computer to the first computer; and wherein at least one of the cumulative difference access threshold and the instant difference access threshold is selected based on the time delay of transmitting access requests from the second computer to the first computer.

15. The method of claim 14, wherein:
the second computer comprises a virtual machine, the virtual machine being configured to operate as a standalone computer system using allocated resources of a cloud provider, the resources of the cloud provider being allocated by at least one processor of the cloud provider configured to operate as a hypervisor, the resources allocated to the second computer comprising a first portion of the at least one processor of the cloud provider, a first portion of at least one memory of the cloud provider, and a first portion of at least one storage module of the cloud provider;
the first computer comprises the first portion of the at least one storage module allocated to the second computer; and
the first computer is configured to determine the first access metric.

16. The method of claim 15, wherein:
the second computer is configured to determine the second access metric and determine if the access condition is met.

17. The method of claim 15, wherein:
a monitoring computer comprises a second virtual machine, the resources allocated to the monitoring computer comprising a second portion of the at least one processor of the cloud provider, a second portion of the at least one memory of the cloud provider, and a second portion of the at least one storage module of the cloud provider;
at least one of the second computer and the monitoring computer are configured to determine the second access metric and determine if the access condition is met.

18. A first computer comprising:
a communication port for communicating with one or more external computers, the one or more external computers comprising a second computer;
a storage module;
a non-transitory computer-readable storage medium storing instructions; and
a processor configured to execute the instructions, the instructions for:
operating the first computer to permit the second computer to access the storage module of the first computer;
receiving a second access metric relative to the second computer, wherein the second access metric measures a magnitude of data flow between the first computer and the second computer;
monitoring the communication port to determine a first access metric relative to the first computer, wherein the first access metric measures a magnitude of data flow between the first computer and the one or more external computers;
comparing the second access metric and the first access metric; and,
based on comparing the second access metric and the first access metric, determining if an access condition is met, and, if the access condition is met, further permitting the second computer to access the storage module of the first computer, otherwise interrupting access to the storage module of the first computer by the one or more external computers.

19. The first computer of claim 18, wherein:
the second computer comprises a plurality of second computers;
the first computer is configured to establish a plurality of communication channels for the plurality of second computers, each communication channel in the plurality of communication channels being established for one of the plurality of second computers;
the second access metric comprises a plurality of channel-specific second access metrics, such that for each communication channel in the plurality of communication channels, the plurality of channel-specific second access metrics comprises an associated channel-specific second access metric for measuring a magnitude of data flow for that communication channel;
the first access metric comprises a plurality of channel-specific first access metrics, the plurality of channel-specific first access metrics comprising an associated channel-specific first access metric for each communication channel in the plurality of communication channels for measuring a magnitude of data flow between the first computer and the one or more external computers via that communication channel;
operating the first computer to permit the second computer to access the storage module of the first computer comprises, for each second computer and each communication channel, operating the first computer to permit the second computer to access the first computer via that communication channel;
determining if the access condition is met comprises, for each communication channel in the plurality of communication channels, determining if the access condition is met for that communication channel;
receiving a second access metric comprises receiving the plurality of channel-specific second access metrics;
monitoring the first computer to determine the first access metric comprises monitoring the first computer at the plurality of communication channels to determine the plurality of channel-specific first access metrics;
comparing the second access metric and the first access metric comprises, for each communication channel in the plurality of communication channels, comparing the channel-specific first access metric and the channel-specific second access metric for that communication channel and that second computer;
based on comparing the channel-specific first access metric and the channel-specific second access metric for each communication channel and each second computer, determining if the access condition is met, and, if the access condition is met, further permitting that second computer to access the first computer via that communication channel, otherwise interrupting access to the first computer by the one or more external computers via that communication channel.

20. The first computer of claim 19 further comprising, for each second computer in the plurality of second computers, before operating the first computer to permit the second computer to access the storage module of the first computer, determining if that second computer is authorized to have access to the storage module of the first computer.
